(19) United States
(12) Patent Application Publication
(10) Pub. No.: US 2023/0178355 A1
(43) Pub. Date: Jun. 8, 2023

(54) ION TRAP SYSTEM AND ION TRAPPING METHOD

(71) Applicant: HUAWEI TECHNOLOGIES CO., LTD., Shenzhen, Guangdong (CN)

(72) Inventors: Weimin Lv, Shenzhen (CN); Zhengyu Li, Shenzhen (CN); Yangchao Shen, Shenzhen (CN)

(21) Appl. No.: 18/159,859

(22) Filed: Jan. 26, 2023

Related U.S. Application Data
(63) Continuation of application No. PCT/CN2021/093869, filed on May 14, 2021.

(30) Foreign Application Priority Data
Jul. 30, 2020 (CN) 202010754806.5

(51) Int. Cl. H01J 49/42; H01J 49/16

(52) U.S. Cl. CPC H01J 49/4255; H01J 49/161; H01J 49/426

(57) ABSTRACT

An ion trap system and an ion trapping method are provided. The ion trap system may include: an ion source, configured to: generate an ion, and shoot the ion to an ion trap; the electromagnetic field device, configured to change a moving direction of the ion, to transfer the ion to an ion trap; and the ion trap, configured to trap the ion transferred by the electromagnetic field device. The electromagnetic field device changes the moving direction of the ion, to transfer the ion to the ion trap.

### CROSS-REFERENCE TO RELATED APPLICATIONS

This application is a continuation of International Application No. PCT/CN2021/093869, filed on May 14, 2021, which claims priority to Chinese Patent Application No. 202010754806.5, filed on Jul. 30, 2020. The disclosures of the afore-mentioned applications are hereby incorporated by reference in their entireties.

### TECHNICAL FIELD

This application relates to the field of quantum computing technologies, and in particular, to an ion trap system and an ion trapping method.

### BACKGROUND

With the development of information technologies, quantum computing attracts increasingly more attention. A particular feature of quantum computing is that a superposition feature of quantum states makes large-scale “parallel” computing possible. This is because a basic principle of quantum computing is to encode information by using quantum bits (that is, ions). A status of a single quantum bit includes not only two classical states 0 and 1, but also a superposed state of 0 and 1, and n quantum bits may be simultaneously in a superposed state of 2ⁿ quantum states. Each quantum algorithm is to perform different quantum operations on different quantities of quantum bits. A larger quantity of quantum bits leads to a stronger parallel acceleration capability of the quantum algorithm and a faster speed of solving a same problem.

There are a plurality of physical systems for constructing the quantum bit, for example, an ion trap system, a superconducting circuit, a nitrogen-vacancy center (NV), a semiconductor quantum dot, and topology quantum computing. An ion trap has a great development potential due to advantages such as relatively long bit coherence time, better fidelity, and potential scalability. An ion trap system uses an internal energy level of an ion as a natural quantum bit (qubit), and has advantages of a small mutual effect with an environment, long coherence time, and high operation and reading fidelity. The ion trap system is one of promising systems of future scalable quantum computing. Formation of the ion trap system may be generally divided into: ion loading (load), laser cooling, state operation, and state reading, and ion loading is an important process of formation of the ion trap system.

Currently, commonly used methods for loading an ion include resistive heating (resistively heating) and laser ablation (laser ablation). A process of loading an ion through resistive heating mainly includes: A large current passes through an atom oven (oven) that is equipped with a simple substance or a compound of a required metal element, heating is continuously performed for approximately 5 minutes to 10 minutes, and when temperature is heated to over hundreds of degrees Celsius (for example, 650 K for Ca), atoms are ejected from a narrow aperture of the atom oven into a central area of an ion trap potential field, a large quantity of atoms form an atom beam, and the atom beam is ejected into the central area of the ion trap potential field. When the atom beam moves to the central area of the ion trap potential field, the atom beam is photoionized by ionized light (usually including two wavelengths) focused in the area to form ions, and therefore is trapped by an action of the potential field. After a laser cooling operation, the ions can be stably trapped in the ion trap. Operations of loading an ion through resistive heating are relatively simple. However, because continuous heating needs to be performed for a long time, temperature in an area of the atom oven is relatively high, and relatively high heat load may be introduced when a high-temperature atom beam is ejected into the central area of the ion trap potential field, and consequently, a refrigeration effect of the ion trap system is affected. A process of loading an ion through laser ablation mainly includes: High-intensity lasers are focused on a metal surface, and as laser energy is deposited, temperature of a partial area of the metal surface increases, and even fusion and vaporization are caused, and a large quantity of metal particles (including ions, atoms, and the like) escape from the metal surface to form a particle beam. When ions are loaded through laser ablation, an exit direction of the atom oven needs to point to a central area of the ion trap. Therefore, pulse ablation light needs to pass through the central area of the ion trap to point to the exit direction of the atom oven. In this way, the pulse ablation light may also cause ablation on an electrode surface of the ion trap, and consequently affects a structure of the electrode surface.

### SUMMARY

This application provides an ion trap system and an ion trapping method, to prevent, as far as possible, excess atoms from being deposited in an ion trapping module.

According to a first aspect, this application provides an ion trap system. The ion trap system may include an ion generation module, an ion transfer module, and an ion trapping module. The ion generation module is configured to: generate an ion, and shoot the ion to the ion transfer module. The ion transfer module is configured to change a moving direction of the received ion, to transfer the ion to the ion trapping module. The ion trapping module is configured to trap the ion transferred by the ion transfer module.

Based on this solution, in the ion trap system, the ion generation module and the ion trapping module may be spatially separated by the ion transfer module; to be specific, the ion generation module does not directly eject an atom to the ion trapping module, but the ion transfer module changes the moving direction of the ion generated by the ion generation module, to transfer the ion to the ion trapping module. This helps prevent excess ions from being deposited in the ion trapping module.

In a possible implementation, the ion transfer module is configured to change the moving direction of the ion by using an electric field and/or a magnetic field.

The moving direction of the ion can be accurately controlled by using the electric field and/or the magnetic field, so that a direction in which the ion enters the ion trapping module can be accurately controlled.

In a possible implementation, the ion transfer module is further configured to stop transferring the ion to the ion trapping module by closing the electric field and/or the magnetic field.

The electric field and/or the magnetic field are/is controlled to be closed, so that the ion transfer module may stop transferring the ion to the ion trapping module. Alternatively, this may be understood as follows: When a quantity of ions trapped in the ion trapping module meets a requirement, the electric field may be immediately closed, so that no ion enters the ion trapping module, and a quantity of ions entering the ion trapping module can be effectively controlled. This can help further prevent excess ions from being deposited in the ion trapping module.

In a possible implementation, the ion transfer module is further configured to select an isotope of the ion by using the magnetic field. In other words, if the ion transfer module changes the moving direction of the received ion by using the magnetic field, the magnetic field may be further used to select the isotope of the ion.

Through selection of the isotope of the ion, a requirement of the ion trap system on purity of an element can be reduced, and this helps reduce costs of selecting materials.

In a possible implementation, the ion transfer module includes a Helmholtz coil or a permanent magnet, and the ion transfer module is configured to: change the moving direction of the received ion by using a magnetic field generated by the Helmholtz coil or the permanent magnet, and adjust a direction in which the ion leaves the ion transfer module to a direction pointing to a first area of the ion trapping module.

In a possible implementation, the ion transfer module includes an electrode plate or a conductive tube, and the ion transfer module is configured to: change the moving direction of the received ion by using an electric field generated by the electrode plate or the conductive tube, and adjust a direction in which the ion leaves the ion transfer module to a direction pointing to a second area of the ion trapping module.

In a possible implementation, the ion transfer module is a first ion trap, the first ion trap is configured to trap the received ion, and the ion transfer module is configured to adjust, by adjusting an electric field size of the first ion trap, a direction in which the ion leaves the ion transfer module to a direction pointing to a third area of the ion trapping module.

In a possible implementation, the ion generation module includes a laser generation module and an atom generation module, the atom generation module is configured to generate an atom and/or an ion, the laser generation module is configured to emit a first laser to the atom generated by the atom generation module, and the first laser is used to ionize the atom into an ion.

In a possible implementation, the ion trap system further includes a deceleration module, the deceleration module is located between the ion transfer module and the ion generation module, and the deceleration module is configured to decelerate the ion generated by the ion generation module, and shoot the decelerated ion to the ion transfer module.

A speed of the ion from the ion generation module can be effectively reduced by using the deceleration module, and this helps improve ion transfer efficiency of the ion transfer module.

According to a second aspect, this application provides an ion trapping method that may be applied to an ion trap system. The ion trap system includes an ion trapping module. The method includes: generating an ion; changing a moving direction of the ion to transfer the ion to the ion trapping module; and trapping the transferred ion by using the ion trapping module.

In a possible implementation, the moving direction of the ion may be changed by using an electric field and/or a magnetic field.

In a possible implementation, transferring the ion to the ion trapping module may further be stopped by closing the electric field and/or the magnetic field.

Further, optionally, an isotope of the ion is selected by using the magnetic field.

In a possible implementation, a moving direction in which the ion leaves a magnetic field generated by a Helmholtz coil or a permanent magnet is adjusted, by using the magnetic field, to a direction pointing to a first area of the ion trapping module.

In a possible implementation, a moving direction in which the ion leaves an electric field generated by an electrode plate or a conductive tube is adjusted, by using the electric field, to a direction pointing to a second area of the ion trapping module.

In a possible implementation, a moving direction in which the ion leaves a first ion trap is adjusted, by adjusting an electric field size of the first ion trap, to a direction pointing to a third area of the ion trapping module.

In a possible implementation, the ion may be decelerated.

For technical effects that may be achieved in the second aspect or any implementation of the second aspect, refer to descriptions of the beneficial effects in the first aspect. Details are not described herein again.

### BRIEF DESCRIPTION OF DRAWINGS

FIG. 1 is a schematic diagram of a structure of an ion trap system according to this application;

FIG. 2a is a schematic diagram of a working principle of an atom generation module according to this application;

FIG. 2b is a schematic diagram of a working principle of another atom generation module according to this application;

FIG. 3 is a schematic diagram of a structure in which an ion trapping module is a surface trap according to this application;

FIG. 4 is a schematic diagram of a structure of an ion trap according to this application;

FIG. 5 is a schematic diagram of a structure of another ion trap according to this application;

FIG. 6 is a schematic diagram of a structure of still another ion trap according to this application;

FIG. 7 is a schematic diagram of a structure of still another ion trap according to this application;

FIG. 8 is a schematic diagram of a structure of still another ion trap according to this application; and

FIG. 9 is a schematic flowchart of an ion trapping method according to this application.

### DESCRIPTION OF EMBODIMENTS

The following describes in detail embodiments of this application with reference to accompanying drawings.

Some terms in this application are explained and described below. It should be noted that these explanations are for ease of understanding by a person skilled in the art, and are not intended to limit the protection scope required by this application.

(1) Penning (Penning) Ion Trap

A Penning ion trap (or referred to as a Penning trap) is an apparatus that can store charged particles, and generally confines ions by using a homogeneous axial magnetic field and a non-homogeneous quadrupole electric field. Specifically, a strong homogeneous axial magnetic field is used to confine a radial track of the charged particles, and the quadrupole electric field is used to confine an axial track of the charged particles. Electrostatic potential generated by using a group of three electrodes is used: One is a ring electrode and two are end cap electrodes. In an ideal Penning ion trap, a ring and an end are a hyperboloid obtained through rotation and extension. When a positive (negative) ion is captured, the end cap electrode is maintained at positive (negative) potential relative to the ring. Such potential creates a “saddle point” in a generation potential well, and therefore ions are confined to a center of an axial direction. The electric field enables the ions to continuously oscillate when moving around the center of the axial direction (oscillating to simple harmonic motion in an ideal state). A magnetic field used in cooperation with the electric field enables the charged particles to draw an epicycloid when moving on a radial plane.

(2) Paul Ion Trap

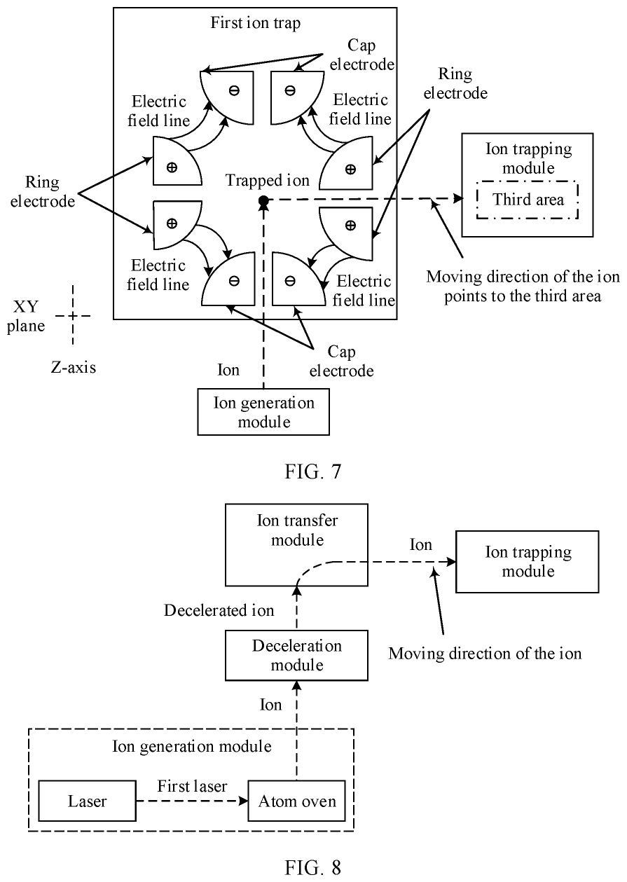

A Paul ion trap (or referred to as a Paul trap) is generally an apparatus that can use a potential well formed by using a quadrupole electric field to store charged particles in a specific area of the trap. An inner surface of the Paul ion trap includes two hyperbolic electrodes (referred to as a cap electrode or an end cap electrode) that rotate around a Z-axis and one hyperbolic ring electrode (referred to as a ring electrode) that uses an XY plane as a symmetrical tangent plane. Refer to a first ion trap shown in FIG. 7 below.

As described in the background, in a current ion trap system, commonly used methods for loading an ion include resistive heating and laser ablation. In both resistive heating and laser ablation, an exit direction of an atom oven needs to point to an area in which ions are trapped, so that an atom beam ejected from the atom oven is directly ejected into the area in which the ions are trapped. Because a large quantity of atoms are ejected from the atom oven, the atoms are prone to be deposited on a surface of an electrode included in the area in which the ions are trapped, and a structure of the surface of the electrode is changed and a stray electric field is introduced. Consequently, fidelity of ion manipulation is reduced. In addition, for a resistive heating manner, continuous heating needs to be performed for a long time, temperature in an area of the atom oven is relatively high, and a relatively large amount of heat may be introduced into a low-temperature ion trap system. For a laser ablation manner, an exit direction of the atom oven needs to point to a central area of the ion trap. Therefore, an ablation laser needs to pass through a central area of an electrode in the ion trap to point to the exit direction of the atom oven. Because instantaneous energy of the ablation laser is relatively high, a surface of the electrode in the ion trap may be ablated, and consequently a structure of the surface of the electrode is affected.

In view of the foregoing problem, this application provides an ion trap system. In the ion trap system, an ion generation module and an ion trapping module may be spatially separated by an ion transfer module; to be specific, an ion generated by the ion generation module is not directly ejected to the ion trapping module, but the ion transfer module changes a moving direction of the ion to transfer the ion to the ion trapping module. This helps prevent excess ions from being deposited in the ion trapping module.

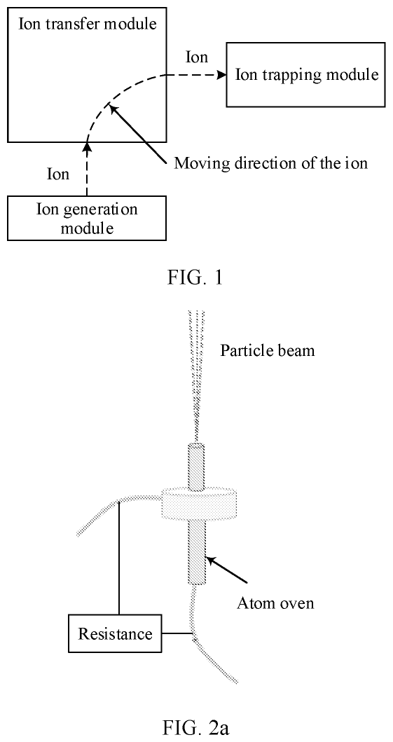

The ion trap system provided in this application is specifically described below with reference to FIG. 1 to FIG. 8.

Based on the foregoing content, FIG. 1 is a schematic diagram of a structure of an ion trap system according to this application. The ion trap system may include an ion generation module, an ion transfer module, and an ion trapping module. The ion generation module may be configured to: generate an ion, and shoot the ion to the ion transfer module. The ion transfer module is configured to change a moving direction of the received ion, to transfer the ion to the ion trapping module. For example, a moving direction in which the ion leaves the ion transfer module points to the ion trapping module. The ion trapping module is configured to trap the ion transferred by the ion transfer module.

Based on the ion trap system, the ion generation module and the ion trapping module may be spatially separated by the ion transfer module; to be specific, the ion generation module does not directly eject an atom to the ion trapping module, but the ion transfer module changes the moving direction of the ion generated by the ion generation module, to transfer the ion to the ion trapping module. This helps prevent excess ions from being deposited in the ion trapping module.

Functional components and structures shown in FIG. 1 are separately described below, to provide an example specific implementation solution.

1. Ion Generation Module

The ion generation module may be referred to as an ion source. The ion generation module may generate an ion, and a large quantity of ions may form an ion beam.

In a possible implementation, the ion generation module may include an atom generation module and a laser generation module, the atom generation module may generate an atom and/or an ion (which may be collectively referred to as a particle) through resistive heating or laser ablation, the laser generation module is configured to emit a first laser to the atom generated by the atom generation module, and the first laser is used to ionize the atom into an ion. Generally, the laser generation module is configured to generate two first lasers. The atom absorbs energy of one photon from one of the first lasers, and then absorbs energy of one photon from the other first laser after jumping to an excited state, so that the atom loses outermost electrons to form an ion. It should be noted that wavelengths of the two first lasers may be equal or unequal. This is not limited in this application. For example, the laser generation module may generate two first lasers. A wavelength of one of the first lasers is 399 nm, and a wavelength of the other first laser is 369 nm. Outermost electrons of the atom may be excited from a ground state to an excited state by using the first laser of 399 nm, and then the outermost electrons in the excited state of the atom are ionized by using the first laser of 369 nm, to form an ion.

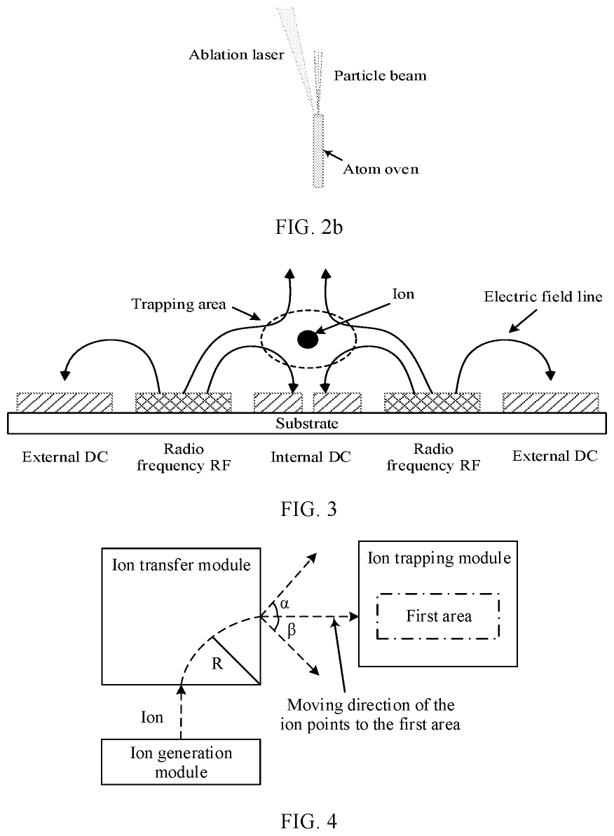

FIG. 2a is a schematic diagram of a working principle of an atom generation module according to this application. The atom generation module generates a particle in a resistive heating manner. The atom generation module may include an atom oven equipped with a metal material. A current flows through the atom oven equipped with the metal material. After the metal material in the atom oven is heated to specific temperature (for example, hundreds of degrees Celsius), a large quantity of atoms are ejected from the atom oven. It should be understood that an atom is generated through resistive heating.

FIG. 2b is a schematic diagram of a working principle of another atom generation module according to this application. The atom generation module generates an atom and/or an ion in a laser ablation manner. The atom generation module may include an atom oven equipped with a metal material. Ablation lasers are focused on a surface of the metal material in the atom oven, and as intensity of the ablation lasers increase, temperature of a metal surface rises, and even fusion and vaporization are caused. A large quantity of metal particles (including atoms and ions) escape from the metal surface to form a particle beam. Through adjustment of the intensity of the ablation lasers, proportions of atoms and ions in the generated particle beam may be changed. When the intensity of the ablation lasers is relatively weak, the atoms in the particle beam account for the majority. As the intensity of the ablation lasers increases, the ions in the particle beam account for the majority.

It should be noted that the ablation laser may be a pulse laser, or may be a continuous laser. In addition, the ablation laser and the first laser are usually from different lasers. This is because instantaneous energy required by the ablation laser is relatively high and the first laser requires a relatively stable frequency. A wavelength of the ablation laser may be equal to or unequal to a wavelength of the first laser. This is not limited in this application.

It should be understood that if particles generated by the atom generation module include an atom, the atom needs to be further ionized to obtain an ion; and if the particles generated by the atom generation module are ions, the ions may be directly shot to the ion transfer module. For example, if the atom generation module is an atom oven, the first laser may be shot to an aperture of the atom oven, to ionize the atom into an ion.

In a possible implementation, the metal material used to generate the particle may be, for example, an element suitable for quantum computing, such as ytterbium (Yb), calcium (Ca), or beryllium (Be).

It should be noted that the ion generation module includes but is not limited to the metal material equipped in the atom oven, or may be a metal block, a metal wire, or the like. This is not limited in this application.

2. Ion Trapping Module

In a possible implementation, the ion trapping module may be configured to trap the ion transferred by the ion transfer module. In this application, the ion trapping module may be a four-rod trap (four-rod trap), a blade trap (blade trap), a surface trap (surface trap), or the like. This is not limited in this application.

FIG. 3 is a schematic diagram of a structure in which an ion trapping module is a surface trap according to this application. The ion trapping module may include a substrate and a direct current (DC) electrode and a radio frequency (RF) electrode that are disposed on the substrate. An ion may be trapped in an ion trapping area under the action of an electric field formed by the DC electrode and the RF electrode. Ions trapped in the ion trapping area may be in one-dimensional arrangement (that is, a one-dimensional ion chain), or may be in two-dimensional planar arrangement. In two-dimensional planar arrangement, the ion has more abundant transfer degrees of freedom and a more stable structure.

It should be noted that an interval between two adjacent ions in one-dimensional ion arrangement or two-dimensional ion arrangement may be equal, or may be unequal. A specific arrangement manner and a quantity of ions trapped in the ion trapping module are related to a to-be-executed quantum algorithm. In addition, the ions trapped in the ion trapping module need to be isolated from an external environment, to prevent another particle from colliding with the trapped ions and causing loss of the trapped ion. Therefore, the ion trapping module is usually in a vacuum system, and the vacuum system may alternatively be an ultra-high vacuum system.

Further, optionally, after the ion is trapped in a trapping area of the ion trapping module, quantum manipulation may be performed on an ion in the ion trap system to complete a quantum task, such as quantum computing, quantum simulation, and quantum precision measurement.

3. Ion Transfer Module

In a possible implementation, the ion transfer module may change a moving direction of the ion by using an electric field, a magnetic field, an electric field and an electric field, or a magnetic field and an electric field, so that the ion is transferred to the ion trapping module. In other words, a moving direction of an ion entering the ion transfer module may be changed by using any one of the electric field, the magnetic field, the electric field and the electric field, or the magnetic field and the electric field, to transfer the ion generated by the ion generation module to the ion trapping module. For example, the moving direction of the ion entering the ion transfer module may be deflected by a specific angle, to transfer the ion to the ion trapping module.

The ion transfer module is described below separately based on different cases.

Case 1: The ion transfer module changes the moving direction of the ion by using the magnetic field.

In a possible implementation, the moving direction of the received ion may be changed by using the magnetic field, and a direction in which the ion leaves the ion transfer module (that is, the magnetic field) is adjusted to a direction pointing to a first area of the ion trapping module. Refer to FIG. 4. After the ion enters the magnetic field, the ion is deflected under the action of Lorentz force in the magnetic field, and therefore the moving direction of the ion is changed. Further, the direction in which the ion leaves the magnetic field may be adjusted to the direction pointing to the first area of the ion trapping module. The first area may be a central area of the ion trapping module, and the central area is generally used to trap ions; or may be any area that is away from the central area of the ion trapping module by a specific distance. This is not limited in this application.

With reference to FIG. 4, because a direction and a speed of the ion generated by the ion generation module are within a range, a size of the magnetic field may be adjusted, so that an exit direction of the ion when leaving the magnetic field points to the first area of the ion trapping module. In other words, the ion transfer module may select an ion with a proper speed to enter the ion trapping module. For example, if the magnetic field is a homogeneous magnetic field, the ion with the proper speed may be selected based on formula 1 to enter the ion trapping module.

$$R = \frac{mv}{Bq} \qquad Formula 1$$

If an included angle between the direction in which the ion leaves the ion transfer module and a center line of the first area of the ion trapping module is 0°, the ion may be exactly ejected to the first area of the ion trapping module. When the included angle between the direction in which the ion leaves the ion transfer module and the center line of the first area of the ion trapping module is a that is greater than 0°, it indicates that a deflection angle of the ion is relatively small and strength of the magnetic field may be increased, so that a turning radius of the ion decreases (in other words, the deflection angle increases), and the included angle between the direction in which the ion leaves the ion transfer module and the center line of the first area of the ion trapping module is made equal to 0° as far as possible. When the included angle between the direction in which the ion leaves the ion transfer module and the center line of the first area of the ion trapping module is that is less than 0°, indicates that the deflection angle of the ion is relatively large and the strength of the magnetic field may be decreased, so that the turning radius of the ion increases (in other words, the deflection angle decreases), and the included angle between the direction in which the ion leaves the ion transfer module and the center line of the first area of the ion trapping module is made equal to 0° as far as possible.

Further, optionally, due to charge-mass ratios

$$\frac{q}{m}$$

of different isotopes of the ion are different, different isotopes of a same metal material are also emitted from the magnetic field in different directions. Therefore, if the ion transfer module is the magnetic field, the magnetic field may be further used to select the isotope of the ion, so that a requirement of the ion trap system on purity of an element can be reduced.

In a possible implementation, the ion transfer module includes a Helmholtz coil (Helmholtz coil), a permanent magnet, or another magnetic element that can generate the magnetic field. It should be understood that a magnetic field generated by the Helmholtz coil or the permanent magnet may be changed by changing magnitude of a current that is input into the Helmholtz coil or the permanent magnet.

It should be noted that the magnetic field may be a homogeneous magnetic field (that is, a uniformly strong magnetic field), or may be a magnetic field that varies with time (that is, an alternating magnetic field).

Based on the case 1, whether the ion transfer module transfers the ion to the ion trapping module may be controlled by controlling on or off of the magnetic field. When a quantity of ions trapped in the ion trapping module meets a requirement, the magnetic field may be immediately closed, so that no ion enters the ion trapping module, and a quantity of ions entering the ion trapping module can be effectively controlled. This can help prevent excess ions from being deposited in the ion trapping module.

Case 2: The ion transfer module changes a moving direction of a particle by using the electric field.

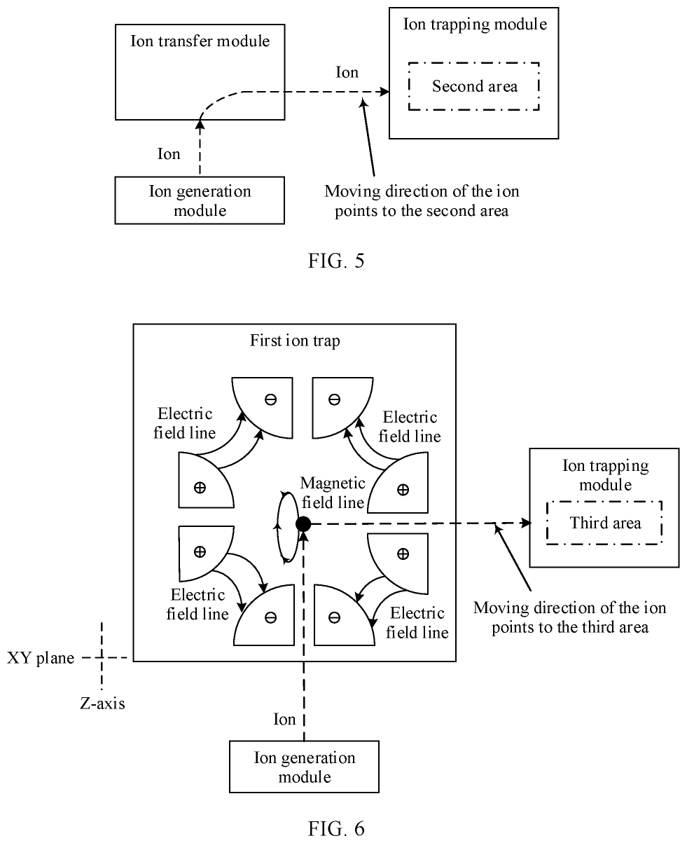

In a possible implementation, the moving direction of the received ion may be changed by using the electric field, and a direction in which the ion leaves the ion transfer module is adjusted to a direction pointing to a second area of the ion trapping module. Refer to FIG. 5. After the ion enters the electric field, the ion is deflected under the action of electric field force in the electric field, so that the moving direction of the ion is changed, and the ion is shot to the second area of the ion trapping module.

It should be noted that the second area may be a central area of the ion trapping module, and the central area is generally used to trap ions; or may be any area that is away from the central area of the ion trapping module by a specific distance. This is not limited in this application. In addition, the second area may be the same as or different from the first area.

With reference to FIG. 5, because a direction and a speed of the ion generated by the ion generation module are within a range, a size of an electric field of the ion transfer module (for example, the ion is in a homogeneous electric field) may be adjusted, so that the direction in which the ion leaves the ion transfer module points to the second area of the ion trapping module.

In a possible implementation, the ion transfer module may include an electrode plate, a conductive tube, or another apparatus that can generate the electric field. Further, optionally, the electrode plate or the conductive tube is energized, so that the electrode plate or the conductive tube generates the electric field.

It should be noted that the electric field may be a homogeneous electric field, or may be an electric field that varies with time (that is, an alternating electric field). It should be understood that for the electric field that varies with time, there is the following case.

Based on the case 2, whether the ion transfer module transfers the ion to the ion trapping module may be controlled by controlling on or off of the electric field. When a quantity of ions trapped in the ion trapping module meets a requirement, the electric field may be immediately closed, so that no ion enters the ion trapping module, and a quantity of ions entering the ion trapping module can be effectively controlled. This can help prevent excess ions from being deposited in the ion trapping module.

Case 3: The ion transfer module changes the moving direction of the ion by using the magnetic field and the electric field.

In a possible implementation, the ion transfer module may be a small ion trap formed by the magnetic field and the electric field, and is referred to as a first ion trap. The first ion trap may be a Penning ion trap (refer to the foregoing related descriptions of the Penning ion trap, and details are not described herein again). FIG. 6 is a schematic diagram of a structure of an ion trap according to this application. The first ion trap is configured to: trap the ion from the ion generation module, and adjust, by adjusting an electric field size of the first ion trap, a direction in which the ion leaves the ion transfer module to a direction pointing to a third area of the ion trapping module. In other words, after the first ion trap traps the ion, a size of the electric field forming the first ion trap may be changed, so that the electric field drives the ion to move toward the ion trapping module, and a direction points to the third area of the ion trapping module.

Based on this case 3, a quantity of ions transferred by the ion transfer module can be accurately controlled by controlling on or off of the electric field and/or the magnetic field. This can help prevent excess ions from being deposited in the ion trapping module.

Case 4: The ion transfer module changes the moving direction of the ion by using the electric field and the electric field.

In a possible implementation, the ion transfer module may alternatively be a small ion trap formed by the electric field and the electric field, and may also be referred to as a first ion trap. The first ion trap may be a Paul ion trap (refer to the foregoing related descriptions of the Paul ion trap, and details are not described herein again). FIG. 7 is a schematic diagram of a structure of another ion trap according to this application. The first ion trap is configured to: trap the ion from the ion generation module, and adjust, by adjusting an electric field size of the first ion trap, a direction in which the ion leaves the ion transfer module to a direction pointing to a third area of the ion trapping module. For example, after the first ion trap traps the ion, a size of an electric field generated by a ring electrode forming the first ion trap may be changed, so that the electric field drives the ion to transfer to the ion trapping module, and a direction points to the third area of the ion trapping module.

It should be noted that the third area in the case 3 and the case 4 may be a central area of the ion trapping module, and the central area is generally used to trap ions; or may be any area that is away from the central area of the ion trapping module by a specific distance. This is not limited in this application. In addition, the third area, the second area, and the first area may be the same, or may be different, or any two of the third area, the second area, and the first area are the same. This is not limited in this application.

4. Deceleration Module

Temperature of the ion ejected from the ion generation module is relatively high (for example, hundreds of K), and an average speed of the ion is approximately hundreds of m/s. To improve ion transfer efficiency of the ion transfer module, the ion generated by the ion generation module may be first decelerated before being emitted to the ion transfer module. In other words, the ion from the ion generation module is first decelerated by the deceleration module (for example, decelerated to tens of m/s), and then emitted to the ion transfer module.

In a possible implementation, the deceleration module may decelerate the ion from the ion generation module by evaporating and cooling the ion. Generally, the temperature of the ion can be reduced from a magnitude of 10 μK to a magnitude of 1 μK, so that phase space density of the ion can also be increased by two to three orders of magnitude. The temperature of the ion can even be reduced to an energy level at which a phase change occurs on the ion, to obtain a Bose-Einstein condensate (temperature magnitude of nK), and this improves ion transfer efficiency of the ion transfer module.

Further, optionally, the deceleration module may be a pure magnetic trap or a pure optical trap. For example, if the deceleration module is a pure magnetic trap, the ion from the ion generation module is evaporated and cooled by using the pure magnetic trap, to reduce the temperature of the ion. The pure magnetic trap may be a structure in which a magnetic field gradient of a Helmholtz coil is rapidly improved after a cooling laser of a magneto-optical trap is turned off, to form a structure in which the ion can be trapped only by using the magnetic field. It should be understood that a process of evaporation and cooling is: An ion with relatively high temperature is continuously removed, remaining ions reach a heat balance through elastic collision, and then an ion with relatively high temperature is generated and is removed. This process is repeated in this way, to implement an effect of cooling the ion. A working principle of the magneto-optical trap is as follows: In a gradient magnetic trap generated by a pair of Helmholtz coils that carry reverse currents, three pairs of cooling lasers (that is, six cooling lasers in total) whose frequencies are close to an atomic energy level difference are added, every two cooling lasers are one pair, cooling lasers in each pair have opposite incident directions, the three pairs of cooling lasers are transmitted toward a center in three orthogonal directions (for example, three directions XYZ), and an intersection point is located in a center of the magnetic trap.

A pure optical trap is a structure for trapping ions by using an optical trap formed by far infrared lasers. A trapping principle is that a frequency of the far infrared laser is hundreds of terahertz different from an energy level of the ion; in other words, the frequency of the far infrared laser is far less than an energy level difference of the ions. After the ion is irradiated by the far infrared laser, the ion is subjected to dipole force of the far infrared laser, and is attracted to a center position with strongest light intensity, so that an ionic group is carried in the far infrared laser, to cool the ion by continuously reducing light intensity of the far infrared laser.

It should be noted that, in a quantum operation process, if the ion trapped in the ion trapping module is lost, the electric field and/or the magnetic field may be opened again, and the ion is re-trapped by using the ion trap system in any one of the foregoing embodiments.

Based on the foregoing content, a specific implementation of the foregoing ion trap system is provided below with reference to a specific hardware structure, for further understanding of a structure of the foregoing ion trap system.

FIG. 8 is a schematic diagram of a structure of still another ion trap system according to this application. The ion trap system may include an ion generation module, a deceleration module, an ion transfer module, and an ion trapping module. The ion generation module includes an atom oven and a laser. For detailed descriptions of the ion generation module, the deceleration module, the ion transfer module, and the ion trapping module, refer to the foregoing related descriptions. Details are not described herein again.

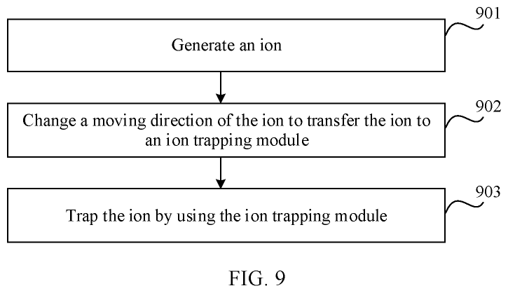

Based on the foregoing content and a same concept, FIG. 9 is an example schematic flowchart of an ion trapping method according to an embodiment of this application. The method may be applied to the ion trap system in any one of the foregoing embodiments, and the ion trap system may include an ion trapping module. The method includes the following steps.

Step 901: Generate an ion.

Step 901 may be performed by the ion generation module in the foregoing ion trap system. For details, refer to detailed descriptions of the foregoing ion generation module. Details are not described herein again.

Step 902: Change a moving direction of the ion, to transfer the ion to the ion trapping module.

Three possible implementations of changing the moving direction of the ion are shown below as examples.

Implementation 1: A moving direction in which the ion leaves a magnetic field generated by a Helmholtz coil or a permanent magnet is adjusted, by using the magnetic field, to a direction pointing to a first area of the ion trapping module.

Implementation 2: A moving direction in which the ion leaves an electric field generated by an electrode plate or a conductive tube is adjusted, by using the electric field, to a direction pointing to a second area of the ion trapping module.

Implementation 3: A moving direction in which the ion leaves a first ion trap is adjusted, by adjusting an electric field size of the first ion trap, to a direction pointing to a third area of the ion trapping module.

Step 902 may be performed by the ion transfer module in the foregoing ion trap system. For details, refer to detailed descriptions of the foregoing ion transfer module. Details are not described herein again.

Step 903: Trap the transferred ion by using the ion trapping module.

Step 903 may be performed by the ion trapping module in the foregoing ion trap system. For details, refer to detailed descriptions of the foregoing ion trapping module. Details are not described herein again.

It can be learned from step 901 to step 903 that, through changing of the moving direction of the ion, the ion may not be directly ejected to the ion trapping module. This helps prevent excess ions from being deposited in the ion trapping module.

In embodiments of this application, if there is no special description or logic conflict, terms and/or descriptions in different embodiments are consistent and may be mutually referenced, and technical features in different embodiments may be combined to form a new embodiment based on an internal logical relationship of the different embodiments.

In this application, “0°”, “90°”, or the like is not an absolute value, and a specific engineering error may be allowed. And/or describes an association relationship between associated objects, and represents that three relationships may exist. For example, A and/or B may represent the following cases: Only A exists, both A and B exist, and only B exists, where A and B may be singular or plural. In text descriptions of this application, the character “/” generally indicates that associated objects are in an “or” relationship. In addition, the word “example” in this application is used to represent giving an example, an illustration, or a description. Any embodiment or design scheme described as an “example” in this application should not be explained as being more preferred or having more advantages than another embodiment or design scheme. Alternatively, this may be understood as follows: Use of the word “example” is intended to present a concept in a specific manner, and does not limit this application.

It may be understood that various numbers in this application are merely used for differentiation for ease of description, and are not used to limit the scope of embodiments of this application. Sequence numbers of the foregoing processes do not mean an execution sequence, and an execution sequence of the processes needs to be determined based on functions and internal logic of the processes. Terms “first”, “second”, and similar expressions are used to distinguish between similar objects, and do not need to be used to describe a specific order or sequence. In addition, the terms “include” and “have” and any variation thereof are intended to cover non-exclusive inclusion, for example, including a series of steps or units. The method, the system, the product, or the device does not need to be limited to those steps or units that are clearly listed, but may include other steps or units that are not clearly listed or that are inherent in the process, the method, the product, or the device.

Although this application is described with reference to specific features and all the embodiments thereof, it is clear that various modifications and combinations may be made to them without departing from the spirit and scope of this application. Correspondingly, this specification and the accompanying drawings are merely example descriptions of this application defined by the appended claims, and are considered as any or all of modifications, variations, combinations or equivalents that cover the scope of this application.

Apparently, a person skilled in the art can make various modifications and variations to this application without departing from the spirit and scope of this application. In this case, this application is intended to cover these modifications and variations provided that they fall within the scope of protection defined by the following claims and their equivalent technologies.

1. An ion trap system, comprising an ion source, an electromagnetic field device, and an ion trap, wherein
the ion source is configured to: generate an ion, and shoot the ion to the electromagnetic field device;
the electromagnetic field device is configured to change a moving direction of the ion, to transfer the ion to the ion trap; and
the ion trap is configured to trap the ion transferred by the electromagnetic field device.

2. The ion trap system according to claim 1, wherein the electromagnetic field device is configured to:
change the moving direction of the ion by using at least one of an electric field or a magnetic field.

3. The ion trap system according to claim 2, wherein the electromagnetic field device is further configured to:
stop transferring the ion to the ion trap by closing the at least one of the electric field or the magnetic field.

4. The ion trap system according to claim 2, wherein the electromagnetic field device is further configured to:
select an isotope of the ion by using the magnetic field.

5. The ion trap system according to claim 2, wherein the electromagnetic field device comprises a Helmholtz coil or a permanent magnet; and
the electromagnetic field device is configured to: change the moving direction of the ion by using a magnetic field generated by the Helmholtz coil or the permanent magnet, and adjust a direction in which the ion leaves the electromagnetic field device to a direction pointing to a first area of the ion trap.

6. The ion trap system according to claim 2, wherein the electromagnetic field device comprises an electrode plate or a conductive tube; and
the electromagnetic field device is configured to: change the moving direction of the ion by using an electric field generated by the electrode plate or the conductive tube, and adjust a direction in which the ion leaves the electromagnetic field device to a direction pointing to a second area of the ion trap.

7. The ion trap system according to claim 2, wherein the electromagnetic field device is a first ion trap;
the first ion trap is configured to trap the ion; and
the electromagnetic field device is configured to adjust, by adjusting an electric field size of the first ion trap, a direction in which the ion leaves the electromagnetic field device to a direction pointing to a third area of the ion trap.

8. The ion trap system according to claim 1, wherein the ion source comprises a laser emitter and an atom oven
the atom oven is configured to generate at least one of an atom or an ion; and
the laser emitter is configured to emit a first laser to the atom generated by the atom oven, and the first laser is used to ionize the atom into an ion.

9. The ion trap system according to claim 1, wherein the ion trap system further comprises a deceleration trap and the deceleration trap is located between the electromagnetic field device and the ion source; and
the deceleration trap is configured to decelerate the ion generated by the ion source, and shoot the decelerated ion to the electromagnetic field device.

10. An ion trapping method, applied to an ion trap system, wherein
the ion trap system comprises an ion trap, and the method comprises: generating an ion;
changing a moving direction of the ion to transfer the ion to the ion trap; and
trapping the transferred ion by using the ion trap.

11. The method according to claim 10, wherein the changing a moving direction of the ion comprises:
changing the moving direction of the ion by using at least one of an electric field or a magnetic field.

12. The method according to claim 11, wherein the method further comprises:
stopping transferring the ion to the ion trap by closing the at least one of the electric field or the magnetic field.

13. The method according to claim 11, wherein the method further comprises:
selecting an isotope of the ion by using the magnetic field.

14. The method according to claim 11, wherein the changing a moving direction of the ion comprises:
adjusting, by using a magnetic field generated by a Helmholtz coil or a permanent magnet, a moving direction in which the ion leaves the magnetic field to a direction pointing to a first area of the ion trap.

15. The method according to claim 10, wherein the changing a moving direction of the ion comprises:
adjusting, by using an electric field generated by an electrode plate or a conductive tube, a moving direction in which the ion leaves the electric field to a direction pointing to a second area of the ion trap.

16. The method according to claim 10, wherein the changing a moving direction of the ion comprises:
adjusting, by adjusting an electric field size of a first ion trap, a moving direction in which the ion leaves the first ion trap to a direction pointing to a third area of the ion trap.

17. The method according to claim 10, wherein the method further comprises:
decelerating the ion.
